(19) United States
(12) Patent Application Publication
(10) Pub. No.: US 2024/0413679 A1
(43) Pub. Date: Dec. 12, 2024

(54) INTEGRATED COMPONENTS FOR VEHICLES

(71) Applicant: Tesla, Inc., Austin, TX (US)

(72) Inventors: Diego Silva, Ben Lomond, CA (US); Scott Michael Graves, Felton, CA (US)

(21) Appl. No.: 18/697,827

(22) PCT Filed: Oct. 12, 2022
(86) PCT No.: PCT/US2022/046432

§ 371 Date: Apr. 2, 2024

Related U.S. Application Data
(60) Provisional application No. 63/262,548, filed on Oct. 14, 2021.

(51) Int. Cl. H02K 1/20; H02K 1/16; H02K 3/24; H02K 7/00; H02K 15/02

(52) U.S. Cl. CPC H02K 1/20; H02K 1/16; H02K 3/24; H02K 7/006; H02K 15/024

(57) ABSTRACT

One or more aspects of the present application relate to cooling management system implemented as part of an electric motor. Illustratively, the cooling management system corresponds to a sealed system/component that surrounding the motor stator magnetic core such that a cooling fluid is able to provide heat mitigation functionality during the operation of the AC induction motor, referred to generally as the electric motor. More specifically, illustratively, the cooling management system includes a reservoir configured to hold a cooling fluid, a pump configured to pump the cooling fluid, a heat exchanger configured to interact with the cooling fluid, and a sealed stator fluid jacket. The sealed stator fluid jacket further includes an over molded inner layer that defines an interior channel characterizing a space for the plurality of stator bars and that defines a plurality of flow channels for the flow of the cooling fluid.

### CROSS-REFERENCE TO RELATED APPLICATION

This application claims the benefit of U.S. Provisional Application No. 63/262,548 entitled INTEGRATED COMPONENTS FOR VEHICLES and filed on Oct. 14, 2021. U.S. Provisional Application No. 63/262,548 is incorporated by reference herein.

### BACKGROUND

Generally described, a variety of vehicles, such as electric vehicles, combustion engine vehicles, hybrid vehicles, etc., can be configured with various components to facilitate operation of the vehicle. Traditionally, many components are specifically configured in accordance with the specifications required to implement the specified functionality. For example, attributes of structural components within a vehicle (e.g., materials, dimensions, mounting, etc.) are specified and selected in a manner that meets or exceeds loads placed on the structural components.

Electric motors are widely used in a variety of industrial and residential applications. In general, this type of motor includes a laminated magnetic core mounted to a drive shaft. The laminated magnetic core may be fabricated from a plurality of laminated magnetic discs, or from a plurality of arc-like core segments. The laminated magnetic core includes a plurality of longitudinal slots into which bars of electrically conductive metal are fit. The ends of the bars extend beyond either end of the laminated magnetic core. An end-ring or endcap at either end of the laminated magnetic core is used to mechanically and electrically join the ends of the rotor bars. As part of an electric motor, the stator is the stationary part of a rotary system that converts the rotating magnetic field to electric current.

### BRIEF DESCRIPTION OF THE DRAWINGS

The present inventions are described with reference to the accompanying drawings, in which like reference characters reference like elements, and wherein:

FIG. 1 is a representation of a cooling management system.

FIG. 2 illustrates a view of the electric motor from FIG. 1.

FIG. 3 is a representation of an endcap of the sealed stator fluid jacket.

FIG. 4A illustrates an embodiment of the sealed stator fluid jacket.

FIG. 4B illustrates an embodiment of the sealed stator fluid jacket.

FIG. 5A is an illustration of a channel of the sealed stator fluid jacket.

FIG. 5B is an alternative view of the channel of the sealed stator fluid jacket of FIG. 5A.

FIG. 6 is an illustration of channels at various stages of manufacturing.

FIG. 7A is an illustration of a channel at a first stage of manufacturing.

FIG. 7B is an illustration of a channel at a second stage of manufacturing.

FIG. 7C is an illustration of a channel at a third stage of manufacturing.

FIG. 7D is an illustration of a channel at a fourth stage of manufacturing.

FIG. 8 is a method of forming a sealed stator fluid jacket.

### DETAILED DESCRIPTION

Generally described, one or more aspects of the present disclosure relate to a cooling management system implemented in a vehicle. More specifically, one or more aspects of the present application relate to cooling management system implemented as part of an electric motor. Illustratively, the cooling management system corresponds to a sealed system/component that surrounding the motor stator magnetic core such that a cooling fluid is able to provide heat mitigation functionality during the operation of the AC induction motor, referred to generally as the electric motor. More specifically, illustratively, the cooling management system includes a reservoir configured to hold a cooling fluid, a pump configured to pump the cooling fluid, a heat exchanger configured to interact with the cooling fluid, and a sealed stator fluid jacket. The sealed stator fluid jacket further includes an over molded inner layer that defines an interior channel characterizing a space for the plurality of stator bars and that defines a plurality of flow channels for the flow of the cooling fluid.

Aspects of the present application correspond to a structure and method of manufacture for a stator component for use in the cooling system that is formed utilized a multi-part process. Namely, as described herein and illustrated, the stator may be formed utilizing a combination of stamping, over-molding and broaching to form a set of precision channels for insertion of bars of the magnetic core and further form cooling channels for the stator windings. By accurately positing and separating slot conductors, fluid passages around the conductors are formed. This results in an increased wetted surface area and reduced thermal resistance to provide for higher overall heat transfer relative to other approaches. Additionally, based in part on the resulting direct fluid contact, the cooling management system can be implemented with a reduced amount of insulation. For example, in some applications, the cooling management system can utilize cooling fluid dielectric properties to provide insulation functionality and mitigate the need for additional insulation materials.

Some conventional approaches to cooling management systems attempt to provide for insulation by utilization of specific materials, including paper, copper, enamel, varnish, and the like. In such approaches, any areas in the cooling management system that are not insulated or considered under-insulated relative to other parts creates inefficiencies in the cooling management system. Additionally, materials utilized for insulation functionality can have a negative impact on the overall thermal performance of the motor. This can result in increased operational costs based on running the electric engine at higher temperatures. In other approaches, the addition of increased amount of insulation materials to address such deficiencies, as discussed above, increased manufacturing costs and complexity.

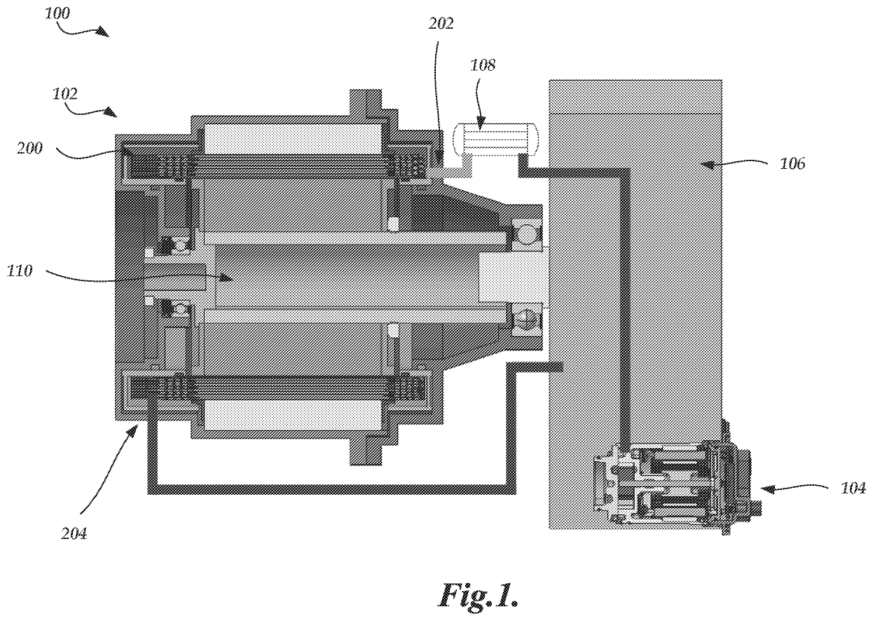

FIG. 1 illustrates a simplified block diagram of a sectional view of cooling management system incorporated into an electric engine in accordance with illustrative embodiments of the present application. As illustrated in FIG. 1, the illustrative cooling management system 100 includes a sealed component, e.g., a sealed stator fluid jacket 200, that encompasses that rotor component 110 of the electric engine 102. The sealed stator oil jacket 200 may also be known as the sealed stator fluid jacket 200. The cooling management system further 100 further includes the pump 104, the reservoir/expansion tank 106, and the heat exchanger 108.

In one embodiment, cooling fluid or fluid flows from the pump, through the heat exchanger and into the sealed stator fluid jacket 200. The cooling fluid passes through the fluid channels formed within the sealed stator fluid jacket 200 (as described herein). Illustratively, the passing of the cooling fluid within the fluid channels in the sealed stator fluid jacket 200 allows the cooling fluid to absorb or extract heat from the stator bars mounted or fixed in the sealed stator fluid jacket 200. The heated cooling fluid then can exit the sealed stator fluid jacket 200 and into the reservoir. In other embodiments, the cooling fluid may flow in the opposite direction, or the components of the system may be placed in a different order. For example, a heat exchanger may alternatively be placed additionally after the cooling fluid exits the sealed stator fluid jacket 200 to extract some of the heat immediately upon leaving the sealed stator fluid jacket 200 and prior to the cooling fluid entering the reservoir. In still other examples, multiple heat exchangers may be placed at different locations in the system to remove heat in the cooling fluid at different points (e.g., prior to entering the sealed stator fluid jacket 200 and immediately after exiting the sealed stator fluid jacket 200). The sealed stator fluid jacket 200 may comprise a system inlet 202 and a system outlet 204. Illustratively, the sealed component isolates the stator cooling functionality from the rest of the electric motor 102.

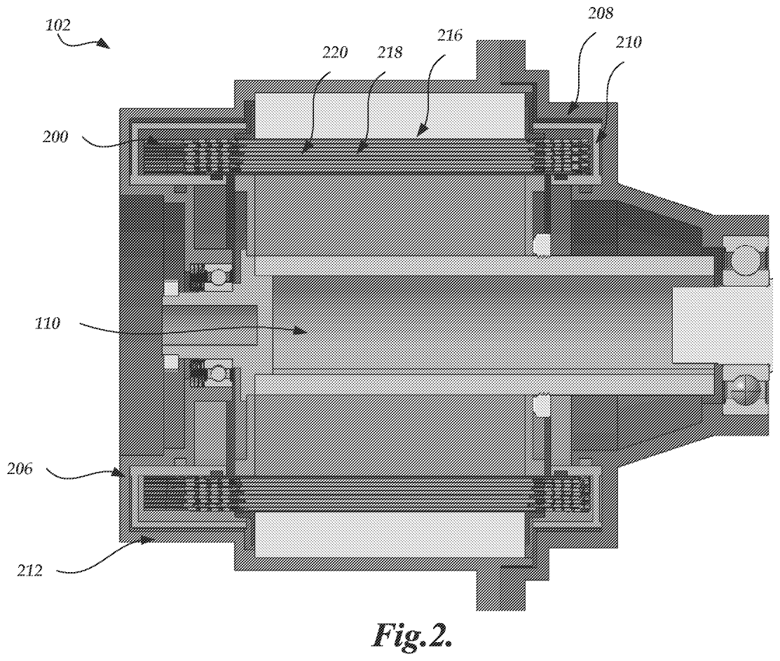

As illustrated in FIG. 2, a first portion of the sealed stator fluid jacket encompasses the rotor component 110 and is of generally cylindrical shape. The sealed stator fluid jacket 200 also includes two end stator components, a first end stator component 206 and a second end stator component 208. The two end stator components may receive partly the ends of the magnetic core bars as illustrated in FIGS. 1, 2, and 3. The first end stator component 206 may be configured to have a stator end inlet 210, a stator end outlet 212, or any combination thereof. The second end stator component 208 may also be configured to have a stator end inlet 210, a stator end outlet 212, or any combination thereof. The fluid 214 may flow through a series of channels 216, in which there are a plurality of stator bars 218 and flow channels 220. In addition to generating current, the stator components form cooling channels that will be provide for heat dissipation.

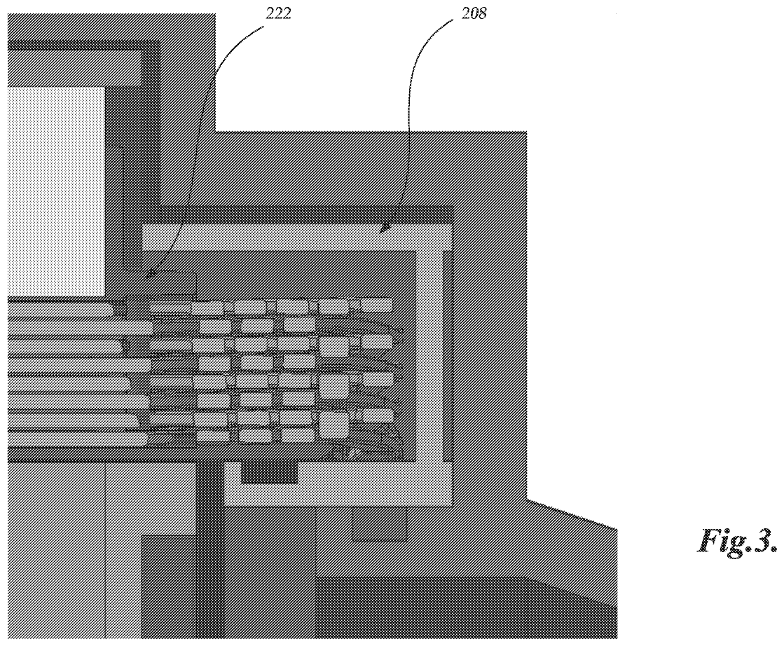

FIG. 3 is a detailed view of a second end stator component 208. The second end stator component 208 seals the end of the sealed stator fluid jacket 200. The first end stator component 206 and the second end stator component 208 may be referred to as an end-cap. The second end stator component 208 may seal to the body 222 of the sealed stator fluid jacket 200 via an engagement clip, screws, glue, gaskets, or any other connection type including high pressure connections. Further the second end stator component may comprise a rotational connection, a rotational and locking connection, or threaded connection. The connection may be made directly to the body 222 or it may be made with another component of the electric motor 102. The second end stator component 208 seals the sealed stator fluid jacket 200, isolating the fluid in it from the rest of the electric engine 102. The first end stator connection may have any of the of characteristics described for the second end stator connection.

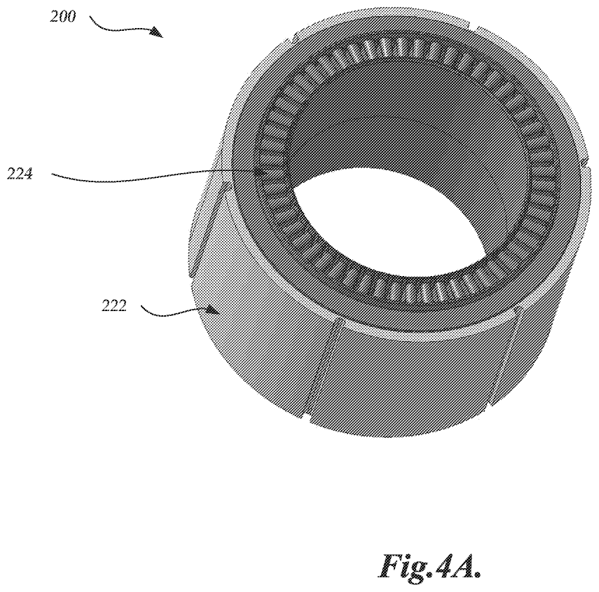

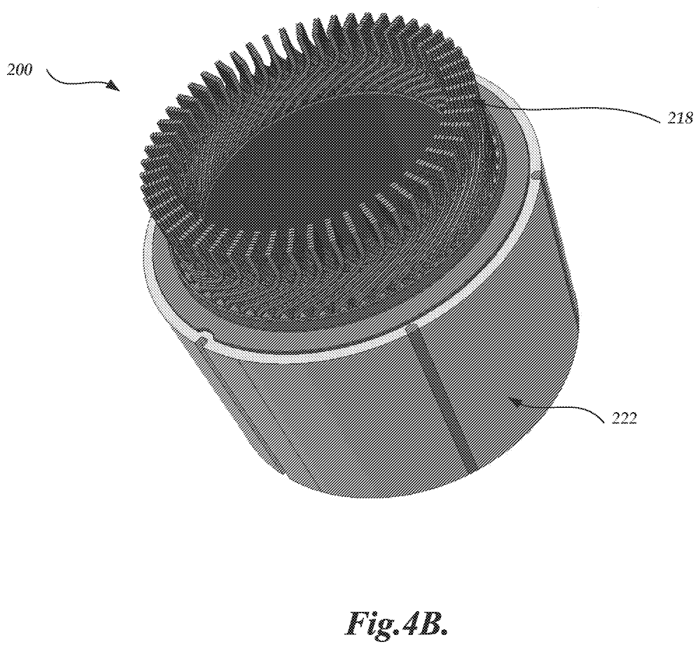

FIG. 4A is a perspective view of the sealed stator fluid jacket 200. The present embodiment of the sealed stator fluid jacket 200 comprises a body 222. The body 222 may also be referred to as the first layer of the channel 216. The body 222 in the present embodiment is made of steel, however it may be may of other materials such as aluminum, composite, carbon, or plastic. The channel 216 further comprises an inner layer 224, also known as the second layer 224. The inner layer 224 in the present embodiment is over molded however it should be understood that it could also be added as an insert or through some other manufacturing method. The inner layer 224 in the present embodiment is made of plastic however a variety of materials may be used.

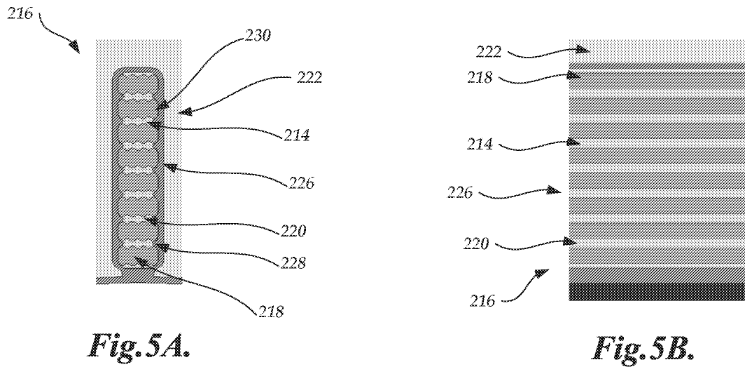

FIG. 4B is a perspective view of the sealed stator fluid jacket 200 in which the plurality of stator bars 218 are press fit into the series of channels 216. The plurality of stator bars 218 may be the copper bars of the present embodiment. The plurality of stator bars 218 may be press fit into slots formed in the channels. The slots may be formed in the over molded material, may be formed in a material that is then inserted, or may be formed directly into the chamber. When the plurality of stator bars 218 are press fit into the plastic insulator components of the stator, they at least partially establish the plurality of flow channels 220. The plurality of stator bars 218 may be bent as shown in the present embodiment. The plurality of stator bars may be bent in a radial pattern, they may be straight, or they may be bent in an alternative fashion. The plurality of stator bars shown in the present embodiment are bent in a hairpin arrangement. The relationship between the stator bars, fluid and other sealed stator fluid jacket components are further illustrated in FIGS. 5A and 5B.

FIGS. 5A and 5B illustrates alternative views of the channel 216. The channel comprises an outer layer, the body 222, and an inner layer, the over molded layer 224. The over molded layer 224 is first over molded and is then broached. Once complete, the over molded layer 224 comprises a plurality of slots 230 and forms the interior channel 226. The slots 230 may be any shape designed to hold the plurality of stator bars 218. The slots 230 may be grooves, ribs, divots, or any shape that can hold the plurality of stator bars 218. The over molded later 224 may be sized such that there is enough interference with the stator bars to facilitate a press fit connect. The gaps between the plurality of stator bars 218 forms the flow channels 220. The flow channels are also formed on either end of the channel 216. All of the flow channels 220 in the present embodiment touch the plurality of stator bars 218, but they need not. The plurality of stator bars may have grooves as shown to increase surface area. The surface of the stator bars may be altered in a number of ways to better facilitate cooling. The flow channels in the present embodiment connect the space in between 228 the plurality of stator bars 218.

Returning to FIG. 1, the cooling management system includes a heat exchanger and fluid reservoir that form a closed system with the sealed stator fluid jacket. Illustratively, the fluid that has been heated is drawn from the sealed stator fluid jacket to the reservoir and passed through a heat exchanger component. The resulting fluid is then provided into the sealed stator fluid jacket 200 via an input line. Illustratively, the type of cooling fluid can correspond to one of a variety of cooling fluids that are utilized in electric motors and have dielectric properties suitable for heat dissipation without interfering with the operation of the components having contact with the fluid, including but not limited to, the rotors and stators of the electric engine. Additionally, the performance parameters of the pump and heat exchanger in the illustrative cooling management system can be selected according to expected environmental conditions experienced or generated by the electric motor and the desired or specified heat dissipation attributes of the cooling management system. Accordingly, the specification and configuration of the cooling fluid, pump and heat exchanger may be interrelated and further dependent on environmental factors.

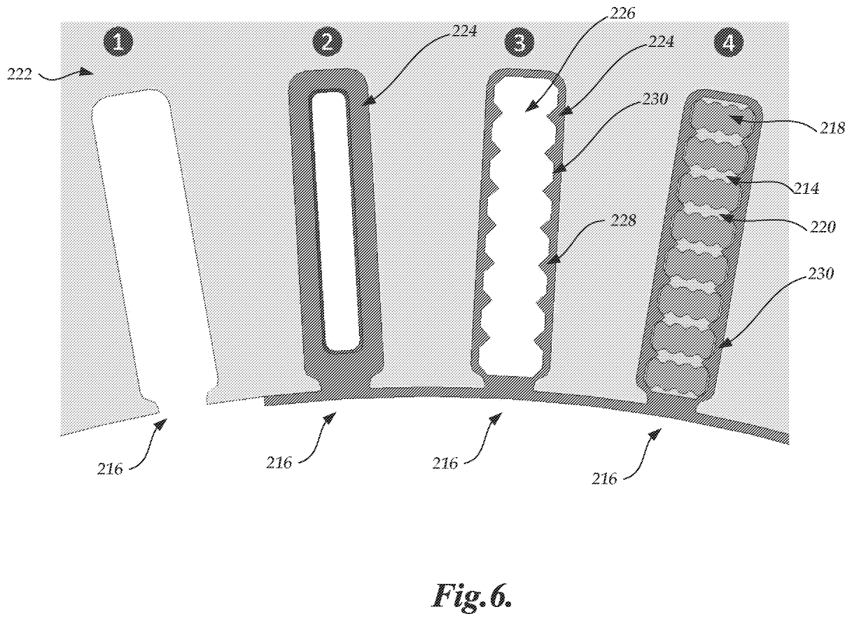

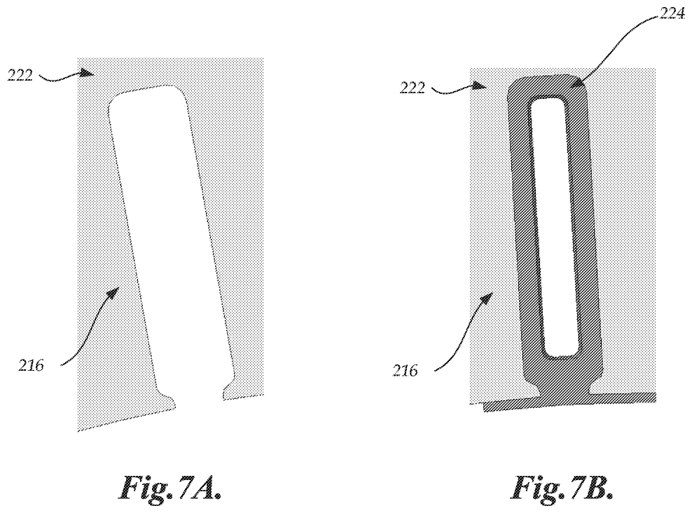

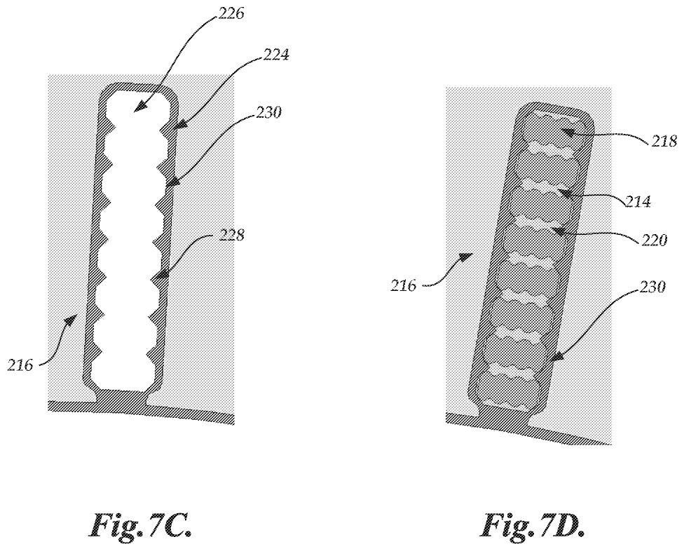

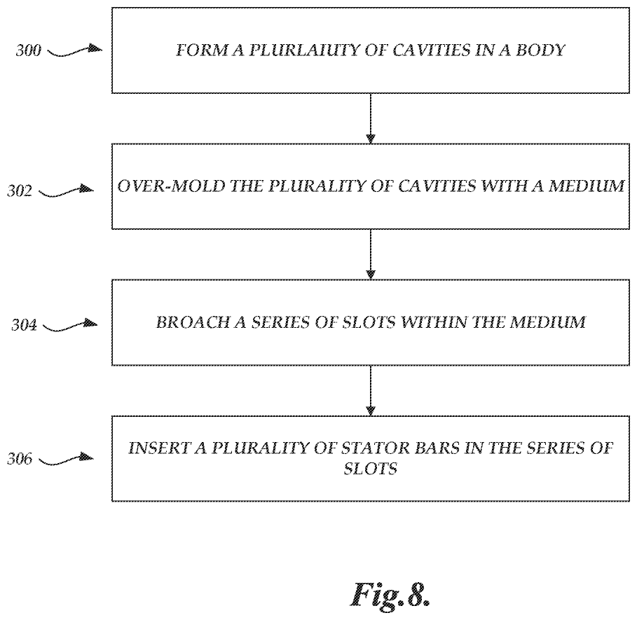

To manufacture the stator components of the cooling management system of the present application, an illustrative process overview is provided in FIG. 6. As illustrated in FIG. 6, at (1) (also shown in FIG. 7A), an individual channel is formed. The individual channel (cavities) 216 may be a cavity formed using a stamping process. The channel 216 may also be formed via machining, casting, bending, pressing or injection molding. In the present case the body 222 is made of steel, however the material may be plastic, carbon, aluminum, metal, or any other suitable material. The cavity illustratively forms the largest dimension of each individual channel.

At (2) (also shown in FIG. 7B), a plastic material is added to the cavity, such as utilizing an over-molding process, which is known in the art. Illustratively, the thickness of the mold generated from the over-molding process is greater than the dimensions of the channels that will be formed. By way of illustration, the molding that is added to the cavity can be in the range of 0.5, 1.0, 1.5, 2.0, 2.5, 3.0 mm and any values in between. Illustratively, the stator over-molding material consists of a non-conductive and non-magnetic material, such as plastic. In other embodiment, a non-magnetic and non-conductive pressed sleeve on the ID of the stator may also be utilized. Further the body may be made of the same material as that of the over molded layer 224, in which case they may be the same part.

At (3) (also shown in FIG. 7C), the molding drafts are broached to form the slots for receipt of the plurality of stator bars. As previously described above the slots may be any feature that is capable of holding the plurality of stator bars such as bumps, divots, grooves, trenches, or the like. In other embodiments, alternative methodologies for material removal may be implemented. These may include injection molding, lasers, water jets, or other suitable methods. Illustratively, each individual molded cavity is broached to obtain high geometric accuracy and meeting a minimum surface finish property. This allows each of the individual stator bars to be securely held in place.

At (4) (also shown in FIG. 7D), the plurality of stator bars are inserted. When inserted the stator bars help to form the flow channels 220 where the fluid 214 passes through, cooling the stator bars. Illustratively, the stator bars will maintain a relatively tight fight with the sealed fluid jacket while providing the cooling channels as disclosed herein. The relatively tight fit further provides for good positioning accuracy and retention of the stator bars.

FIG. 8 illustrates an embodiment of the method of manufacturing sealed stator fluid jacket 200. The method includes block 300, forming a plurality of cavities 216 in a body of the sealed stator fluid jacket. As previously mentioned, these cavities may be stamped, pressed, machined, cast, injection molded, water cut, laser cut, or any other suitable process. Block 302 includes over-molding the plurality of cavities with a medium. The medium may be plastic, carbon, wax, or any other suitable medium. Illustratively, in some embodiments, the over-molding process of block 302 may include over-molding such that a thickness of the medium is greater than a desired/specified thickness of a final channel that will be formed.

At block 304, the process includes broaching a series of slots within the medium to produce the final channel. As described above, the slots may be slots or they may be any shape suitable for holding the stator bars. Further the broaching of the slots and the finished surface of the interior channel 226 may be done through a variety of process such as lasers, water cutting, injection molding, or any other high precision method. Step 306 comprises inserting a plurality of stator bars within the series of slots. Inserting the plurality of stator bars may be done via press fitting, or it may be done via other suitable methods.

Illustratively, one or more aspects of the present application could be applied to any electric stator manufactured in a way where the slots can be closed (Hair pin winding for example), and the conductor could be easily positioned on the defined cooling channels, (not suitable for random winding stators). One benefit of aspects of the present application may be to increase the capability of our motors to deliver high power for long periods of time which will help with scenarios like towing and track ability. Additionally, aspects of the present application may open the possibility of using smaller motors, which together with cheaper conductor bars due to relaxed insulation requirement. More specifically, in some aspects, the cooling fluid dielectric properties will provide for at least a portion of the desired insulation functionality of the motor. In some aspects, the need for additional insulation materials may be reduced or mitigated. In other aspects, additional insulation materials may be eliminated completely.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed air vent assembly. It is to be understood that the forms of disclosure herein shown and described are to be taken as representative embodiments. Equivalent elements, materials, processes, or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application

What is claimed:

1. A cooling system for an electric vehicle, the cooling system comprising:
a reservoir configured to hold a cooling fluid;
a pump configured to pump the cooling fluid;
a heat exchanger configured to interact with the cooling fluid; and
a sealed stator fluid jacket comprising;
a plurality of stator bars; and
a plurality of channels;
wherein the plurality of channels comprise an outer layer and an over molded inner layer;
wherein the over molded inner layer defines an interior channel defining a space for the plurality of stator bars and a plurality of flow channels;
wherein the heat exchanger is configured to remove heat, through the plurality of flow channels of the sealed stator jacket.

2. The cooling system of claim 1, wherein the over molded outer layer comprises a series of slots configured to hold the plurality of stator bars.

3. The cooling system of claim 2, wherein the series of slots are configured to hold the plurality of stator bars via a press fit interface.

4. The cooling system of claim 2, wherein an individual flow channel of the plurality of flow channels is defined by walls of the interior channel between the series of slots and the plurality of stator bars in the series of slots.

5. The cooling system of claim 2, wherein the series of slots are formed via a broaching process.

6. The cooling system of claim 1, wherein the sealed stator fluid further comprises a stator end component configured to receive an end portion of the stator bars.

7. The cooling system of claim 1, wherein the plurality of stator bars are bent in a hairpin formation.

8. The cooling system of claim 1, wherein the outer layer of the channel comprises a body of the sealed stator fluid jacket.

9. The cooling system of claim 1, wherein the over molded outer layer comprises a plastic.

10. The cooling system of claim 1, wherein the stator bars are grooved to create additional contact area with the fluid within the flow channel.

11. A sealed stator fluid jacket for an electric motor, the sealed stator fluid jacket comprising:
a plurality of stator bars; and
a body comprising a plurality of channels, wherein the plurality of channels comprise an over molded layer; and
wherein the over molded layer forms an interior channel defining a space for the plurality of stator bars and a plurality of flow channels.

12. The sealed stator fluid jacket of claim 11, wherein the over molded layer comprises a series of slots; and
wherein the plurality of stator bars are located within the series of slots.

13. The sealed stator fluid jacket of claim 11, wherein an individual stator of the plurality of stators comprises a first stator side and a second stator side;
wherein the plurality of flow channels are located on the first stator side and the second stator side.

14. The sealed stator fluid jacket of claim 11, wherein the sealed stator fluid further comprises a stator end component configured to receive an end portion of the stator bars.

15. The sealed stator fluid jacket of claim 11, wherein the stator bars are grooved to create additional contact area within the flow channel.

16. The sealed stator fluid jacket of claim 11, wherein the over molded layer holds the plurality of stator bars within the sealed stator fluid jacket.

17. A method of forming a sealed stator fluid jacket, the method comprising:
forming a plurality of cavities in a body of the sealed stator fluid jacket;
over-molding the plurality of cavities with a medium, wherein a thickness of the medium is greater than that of a final channel that will be formed;
broaching a series of slots within the medium to produce the final channel; and
inserting a plurality of stator bars within the series of slots.

18. The method of claim 17 wherein inserting the plurality of stator bars within the series of slots comprises press fitting the plurality of stator bars with the series of slots.

19. The method of claim 17, wherein forming the plurality of cavities in the sealed stator fluid jacket comprises stamping the plurality of cavities in the sealed stator fluid jacket.

20. The method of claim 17, wherein the final channel comprises a series of slots configured to hold the plurality of stator bars.
